(19) United States
(12) Patent Application Publication
(10) Pub. No.: US 2020/0258420 A1
(43) Pub. Date: Aug. 13, 2020

(54) PERSONALIZED AND ADAPTIVE MATH LEARNING SYSTEM

(71) Applicant: HETAL B. KURANI, SUNNYVALE, CA (US)

(72) Inventor: HETAL B. KURANI, SUNNYVALE, CA (US)

(21) Appl. No.: 16/273,124

(22) Filed: Feb. 11, 2019

(51) Int. Cl. G09B 19/02; G06N 3/00; G06N 3/04; G06N 3/08; G09B 7/04

(52) U.S. Cl. CPC G09B 19/025; G06N 3/008; G09B 7/04; G06N 3/08; G06N 3/0454

(57) ABSTRACT

A personalized and adaptive automated math learning system and method based on personal attributes, structured prediction, and reinforcement learning is disclosed. The personalization is achieved by data mining the personal attributes and creating competency clusters. The lesson plan and course is designed based on learners' competency levels to teach the subject matter in the shortest possible time. The adaptive automated machine learning method can change teaching methods and formats to become more interactive. After completion of the course, learners are expected to achieve expert competency.

### FIELD OF THE INVENTION

This application relates generally to the field of electronic learning and artificial intelligence and more specifically to personalized and adaptive math learning system.

### DESCRIPTION OF THE RELATED ART

Math is a difficult subject on its own, yet people usually find a way to logically understand it. Sometimes, although, students are not interested in the subject, causing them to not try, resulting in their failure. However, failure in the subject can also result from poor teaching, not studying, not doing homework, and being taught with examples that have no practical application.

Textbooks and course materials are printed in large numbers to fit the needs of average students and teachers. However, teachers have different teaching styles; students have different characteristics, causing much of the material taught to be misunderstood. The personalized and adaptive math learning system fixes this problem so that there is a way to successfully teach students material taught in class in different ways that cater to their different characteristics and backgrounds so they can relate. This way, students can learn math in a learning style that is fit for them. The smart machine learning algorithms and methods also detect the need for special education based on genetic and physiological attributes profile of the learner which current learning systems lack.

This personalized and adaptive math learning system is different from other learning applications because it uses a personalized, adaptive, virtual, and interactive learning environment. The machine learning method is iterative based on response variables. If the student response is incorrect, the user interface can display different methods for solving problems. Interactive features like voice recordings of the questions are included for students that better understand information when it is read aloud. Furthermore, questions are asked along the way to make sure the student understands the information being presented to them.

### SUMMARY OF THE INVENTION

A computer system useful for implementing personalized and adaptive mathematics learning. The computer system includes an operating system and a memory. The memory includes a pedagogical model. The pedagogical model provides and manages a virtual human-like interface between a student and a learning content in an online learning environment to guide a learning processes. The memory includes a domain model. The domain model describes and models a set of real-world entities and relationships. The memory includes a student model. The student model describes attributes and provides a set of individualized course contents and study guidance. The student model suggests a set of optimal learning objectives. The memory includes a machine learning module that implements a personalized and adaptive machine learning method. The personalized and adaptive machine learning method presents a plurality of learning items to the student based on a set of attributes data and a student response. The memory includes a trial loop module that implements a trial loop that includes one or more learning trials. The learning trials are presented to the student based on an answer to a question and the student response. A question database includes a plurality of learning items. A learning item is presented on each learning trial. A trial record database that stores response data regarding the student's response to each learning item. The response data includes data relating to accuracy. A personalized and adaptive system that continues until the learner has achieved the highest level of competency.

### BRIEF DESCRIPTION OF THE DRAWINGS

FIG. 1 illustrates an example overall personalized and adaptive math learning system design including a learner (student), administrator and software, according to some embodiments.

FIG. 2 to depicts an exemplary personalized and adaptive math learning end to end application workflow offering customized lessons to learners.

FIG. 3 illustrates personalized and adaptive machine learning method to create customized lessons for a learner.

FIG. 4 is a diagram of a learner personalization model to analyze, classify and cluster various attributes and associated parameters.

FIG. 5 is a diagram of an adaptive learning model to predict learning model based on learning cluster neural network, Bayesian predictive learning model, structured prediction and reinforcement learning.

FIG. 6 illustrates an example software graphical user interface of the personalized and adaptive math learning application containing menu items for student and administrator.

FIG. 7 illustrates an example personalized and adaptive math learning application software architecture including a software user interface, methods, algorithms, and a database, according to some embodiments.

FIG. 8 is a diagram of an exemplary personalized and adaptive math learning software architecture to implement various lessons through software user interface, quiz results and lesson database.

FIG. 9 illustrates an example block diagram of the personalized and adaptive math machine learning method.

FIG. 10 illustrates an example block diagram of the personalized and adaptive lesson plan database design according to some embodiments

The Figures described above are a representative set, and are not an exhaustive with respect to embodying the invention.

### DESCRIPTION

Disclosed are a system, method, and article of manufacture for generating a personalized and adaptive learning system. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, machine learning techniques, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The personalized and adaptive math learning system complies with eLearning standards which are common set of rules that apply to content, authoring, software and learning management systems (LMSs). This includes installation of the software in the cloud and access through mobile app and browsers like Internet Explorer, Safari, Firefox and so on. The courseware design standards include instructional design, visual design, writing standards, presentation format and assessment standards. The course complies to SCROM (Sharable content Object Reference Model) technical standard which provides interoperability and portability. Interoperability allows a course to communicate with any other SCORM related course or Learning Management System. Portability allows the course to be ported to various Learning Management Systems, which are, again, SCORM compliant. The system also adheres to important requirements of other eLearning standards like Aviation Industry Computer Based Training Committee (AICC), IEEE Learning Technology Standards Committee (LTSC), Advanced Distributed Learning Initiative (ADL), ISO 21001 Educational Organizations—Management systems for educational organizations—Requirements with guidance for use, ISO/IEC 20016 Information technology for learning, education and training—Language accessibility and human interface equivalencies (HIES) in e-learning applications—Part 1: Framework and reference model for semantic interoperability.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Exemplary Definitions

Adaptive Learning—An ability of a teacher or an automated machine learning method to change their teaching actions or approach to improve student learning. In an online environment, it allows the teacher or the machine learning method to analyze the learning processes of individual students on a continuous basis and make modifications for better learning outcomes.

Administrator—The administrator of a subject being taught.

Assessment—A means of comparing students' actual achievement with a desired standard of achievement as outlined in the lesson plan.

Brainstorming—A collection of lesson ideas shared in a group encouraging free expression.

Competency—Skills and knowledge acquired by a learner.

Course—A set of classes in a subject.

Course Design—The systematic planning of a period of study for a particular group of students.

Curriculum Planning—A plan or a timetable of a group of educational activities for a particular course—aims, content, methods, evaluation.

Domain Model—A way to describe and model real world entities and relationships. The model can then be used to solve problems related to that domain.

Evaluation—The process of reviewing particular areas of study to estimate their effectiveness according to student needs and any changing factor.

Feedback—Information received by the teacher or machine learning method about the success of, or problems experienced with, a session or course as it is progressing.

Learner (student)—A person who is learning a subject or skill. Learner and student are used interchangeably in the document.

Learning Objects—the collection of content and learning resources maintained in a content repository.

Learning Objectives/Outcomes—Specific statements of behavior by a student after a period of learning—proving they have learned.

Learning Strategies/Teaching Methods—Activities chosen by the teacher or machine learning method to help students learn.

Lesson—an amount of teaching given at one time; a period of learning or teaching.

Lesson Plan—A ‘sketch map’ of a particular session for a particular group of students, based on objectives and teaching methods with intended timing of activities.

Machine Learning—A method of data analysis that automates analytical model building. Machine learning is a branch of artificial intelligence that uses statistical techniques to give computer systems the ability to “learn” from data, without being explicitly programmed.

Pedagogical Agent—A virtual human-like interface between the learner and the content, in online learning environments to help guide the learning processes.

Personalization—An innovative approach to tailoring lessons that takes into account differences in students learning capabilities and personal backgrounds. It is based on student or learner attributes like Personal profile. Personal interest, Instructional format, Performance, Cognitive skills, Behavior, Genetic, Physiological characteristics and Family background. The goal of the personalization learning is to target the right lessons to the right students at the right time.

Reinforcement Learning—A type of machine learning technique that enables an agent to learn without an intervention from a human in an interactive environment by trial and error using a system of reward and penalty from its own actions and experiences.

Structured Learning—Consists of programs or course that are designed using instructional methodologies. It consists of structured courses and curriculums.

Student Model—System to provide individualized course contents and study guidance, to suggest optimal learning objectives.

Syllabus—A statement of aims and content for subject areas.

Teacher—A person who teaches.

### Example Embodiments

In one example embodiment, a personalized and adaptive math learning system includes of a software app, innovative machine learning methods, and database. The database includes lessons and quizzes on multiple math concepts such as addition, subtraction multiplication, division, and square roots etc. Since the system is personalized and adaptive, simpler variations of these math concepts exist for students that would learn better with them. Each students' personalized attribute information is entered into the system including their personal profile, interest, instructional format, performance, cognitive, behavior, genetic, physiological and family background. At the beginning of each lesson, there is a personalized quiz on basic concepts that the student is required to know to complete the lesson. The same mathematical quiz is presented by the innovative machine learning method in a different contextual form to a different student in a personalized manner. The adaptive machine learning method analyzes the learning processes of individual students on a continuous basis and makes modifications for better learning outcomes. Based on whether the student fails or passes this quiz, they can be taken to an easier or harder version of the lesson till they complete the lesson and achieve competency.

One example embodiment includes a personalized and adaptive math learning system with an automated machine learning method that is used to target students' learning by tailoring lessons that take into account the differences in their learning capabilities. The optimal fast learning method is personalized based on individual student's attributes. It is adaptive in the sense that its machine learning method continuously monitors a student's accuracy of response in answering a series of math questions by performing a series of steps, and modifies the sequencing of the items presented as a function of these variables for better learning outcomes. One of the goal of the personalization learning is to target the right lessons to the right students at the right time. The adaptive machine learning method may be used independently or in conjunction with iterative learning and hinting methods.

One example embodiment includes a means of creating a lesson plan by the teacher and taking the lesson plan by the student. Online learning allows a student to take a lesson at their own time and also for those who are not able to come to a physical campus. Most of the current implementations of learning environments lack the support that individual students need to learn the subject. An example embodiment is designed to use personalization and adaptive learning data to provide automatic customization of learning and instruction to individual learners.

There are various types of learning environments that support different learning activities. For example, there are two types of online learning environments: synchronous and asynchronous. Synchronous means “at the same time” and it involves online learning interaction of students with an instructor via the web in real time. Participants interact with each other and the instructor through instant messaging, chats, video conferencing etc. The session can be recorded and played back. This allows for possibilities of global connectivity and collaboration opportunities among learners. Asynchronous means “not at the same time” and it allows the participants to complete the online web based training on their own pace without live interaction with the instructor. The lessons are accessible on a self-help basis, 24/7, around the year. The advantage is that this kind of e-learning offers the learner information access from anywhere to anytime. It also has interaction amongst learners and teacher through message boards, discussion forum, social media groups, video chats etc. The problem with both of these environments are that they are teacher or instructor driven, offered to simultaneously reach an unlimited number of students and lack the personalization and adaptive learning.

In an example case of a supervised human teacher, learning the personalization and adaptive learning can be done by teachers based on their experience. In case of unsupervised online learning, the computer has to follow the instruction based on the data. In case of online learning, a common algorithm is used for different subjects. These algorithms are used as one size fits all, for various kind of domain models including different subject areas like English, Arts, Science, Math, Geography, History and so on. For a machine to either personalize or learn from the responses, the same machine learning method does not work because in case of English lessons, some of the essay or written answers are qualitative, for Science lessons they can be semi-quantitative or semi-qualitative whereas for math the questions and answers are mostly quantitative. This is further complicated by the fact that written answers cannot be easily graded. To solve this problem, a novel personalized and adaptive machine learning method has been implemented which not only works for math but other subjects as well. It is dynamic in nature and adapts based on subject type, question type, and whether the questions are quantitative, semi quantitative/qualitative or qualitative in nature.

Personalization can be an approach to tailoring lessons that takes into account differences in students' learning capabilities and personal backgrounds. The goal of personalized learning is to target the right lessons to the right students at the right time. For example, if one of the student's family background is from a science field and another student's is from farming, then the personalization of learning for both students would mean understanding their family backgrounds. In this case, the interface can provide the same math lessons in a different contextual format so they are familiar to the problem.

The adaptive learning model allows the teacher or the machine learning method to analyze the learning processes of individual students on a continuous basis and make modifications for better learning outcomes. For example, the environment recommends to every student with insufficient competency in a quiz to go through the associated learning unit again before being allowed to proceed to the next unit. It will also offer the instructional format based which is well suited for the learner. This also includes the evaluation and review of particular areas of the study to estimate their effectiveness according to the student's needs.

In the absence of the teacher it becomes very important to have personalization and adaptive learning using machine learning methods by providing appropriate support, help and feedback to the students.

The personalization and adaptive learning machine learning looks at individual student's needs, attributes, personal interests, instructional format, performance, cognitive skill, behavior, genetics, physiological characteristics, family background and so on. Based on these parameters, it can recommend what kind of learning experience would best suit each individual student till they achieve competency in the subject. If the attribute parameters data is missing, the machine learning method assigns values based on probabilistic model.

Exemplary Systems and Methods

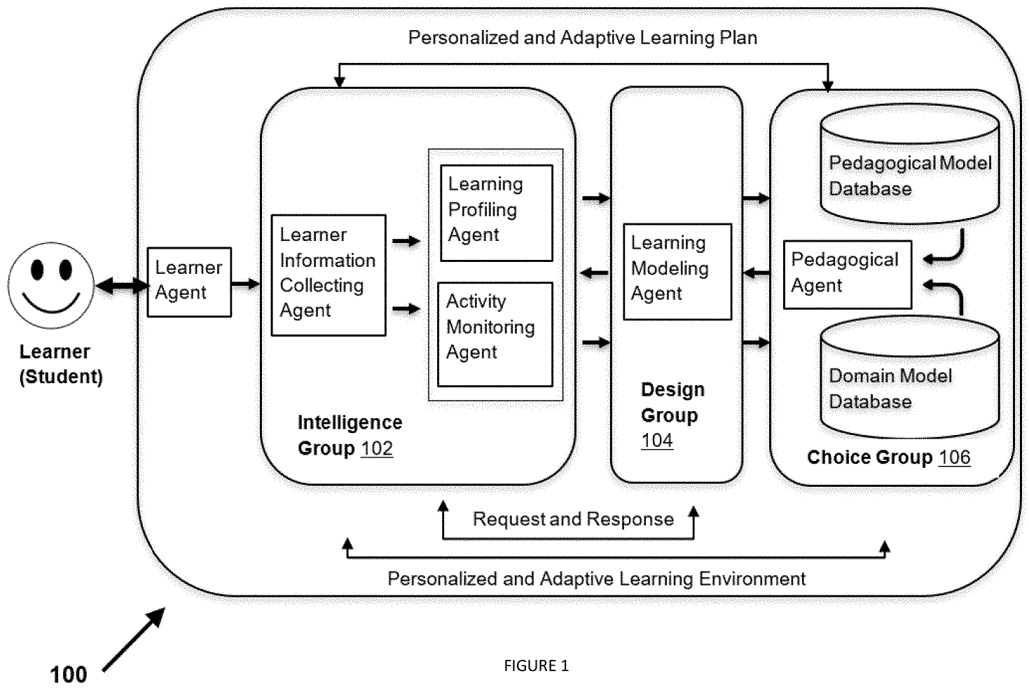

FIG. 1 illustrates an example overall personalized and adaptive math learning system 100, according to some embodiments. System 100 can include an intelligence group 102, a design group 104, and a choice group 106. Through the learner agent (e.g. software graphical user interface), the student inputs data into the system. This data goes through the intelligence group 102, where it gets collected by the student information collecting agent and goes through the student profiling agent. The learning profiling agent is responsible for collecting the student's characteristics like personal profile, interest, cognitive skills, behavior, genetic, physiological characteristics, family background and performance. This information is used to personalize the lesson content. The data is then passed on to the design group 104, where it goes through the student modeling agent. Finally, the data is passed on the choice group 106, where it goes through the pedagogical agent and then goes back to the student information collecting agent in the intelligence group 102. The data is once again passed on to the student profiling agent, but this time, it goes to the activity monitoring agent afterward, which sends the data output back to the interface.

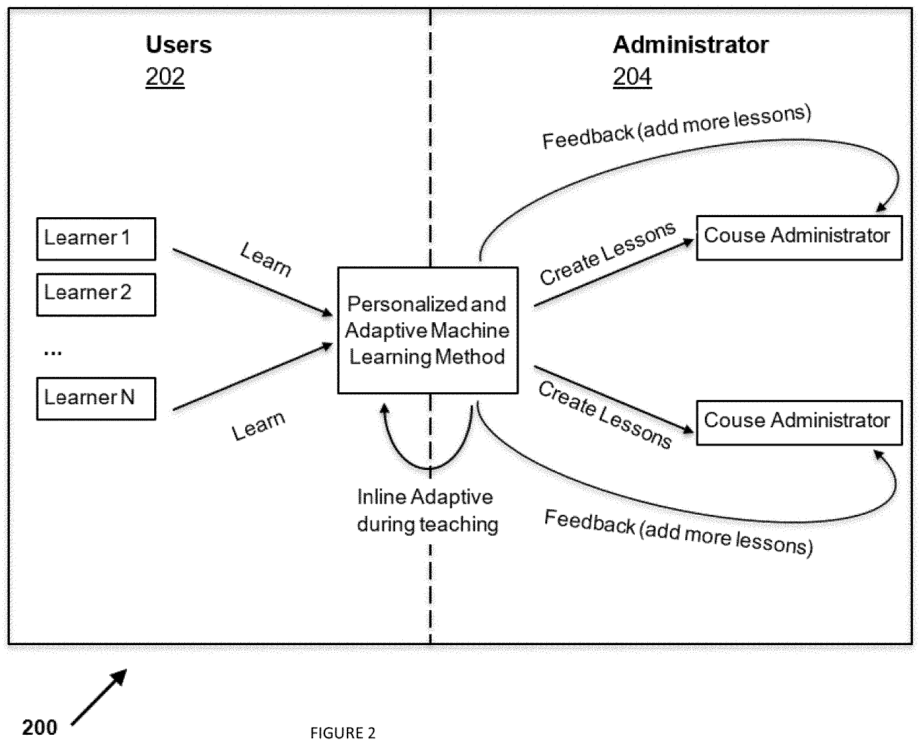

FIG. 2 depicts an exemplary personalized and adaptive math learning end to end application workflow to offer customized lessons to learners, according to some embodiments. The administrator 204 creates all the course activities and the personalized and adaptive machine learning method rearranges lesson plan to create fit for the student. Then the user 202 can learn from these lessons and quizzes. Every time the learner submits a quiz, the algorithm can change based on their performance on the quiz. The adaptive machine learning method using student's attribute data can keep changing dynamically like this until the learner is to the final quiz of the lesson. It consists of machine learning algorithms and statistical models to perform the task of learning math. It uses unsupervised learning algorithms since it only consists of set of data that contains only student inputs, and find structure in the data, like grouping or clustering of data points. In case, if all the student data is not available it uses the predictive model to best guess the data as part of the input set.

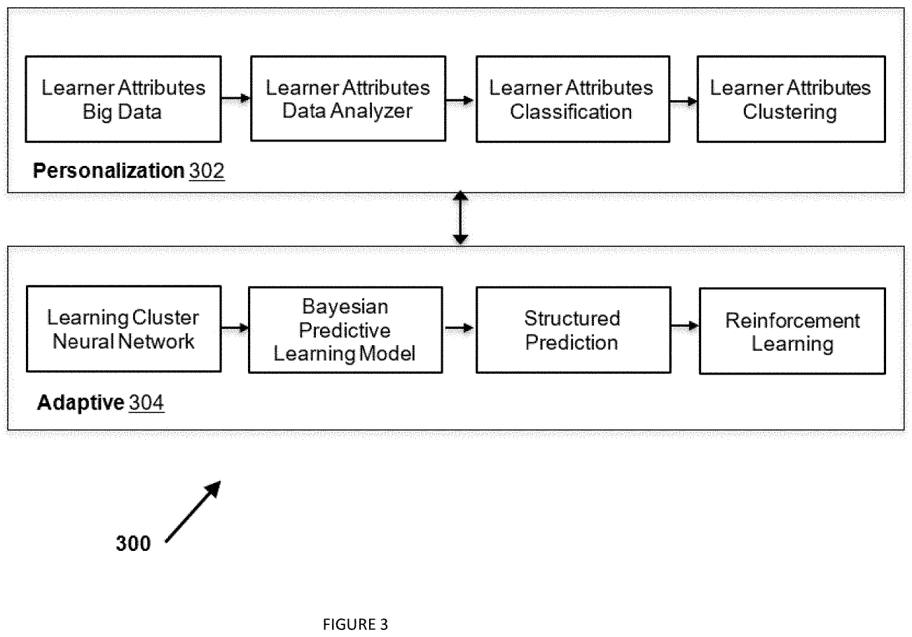

FIG. 3 illustrates personalized and adaptive machine learning process 300 used to create customized lessons for a learner, according to some embodiments. Process 300 includes personalization step 302, which is implemented after the learner attributes are entered. In personalization step 302, the attribute data is analyzed, classified and clustered.

In an adaptive step 304, process 300 implements a learning cluster neural network, Bayesian predictive learning model, structured prediction and reinforcement learning is responsible for analyzing the learning processes of individual students on a continuous basis and make modifications for better learning outcomes. This is enabled by learning cluster neural network learning pathways framework. The Bayesian predictive learning model is responsible for selecting the best lesson based on the given learner data. The structure prediction model is used based on the learner attributes to present the problem statement which best fits their profile. The reinforcement learning focuses on the student performance to find the right balance between current knowledge and uncharted territory.

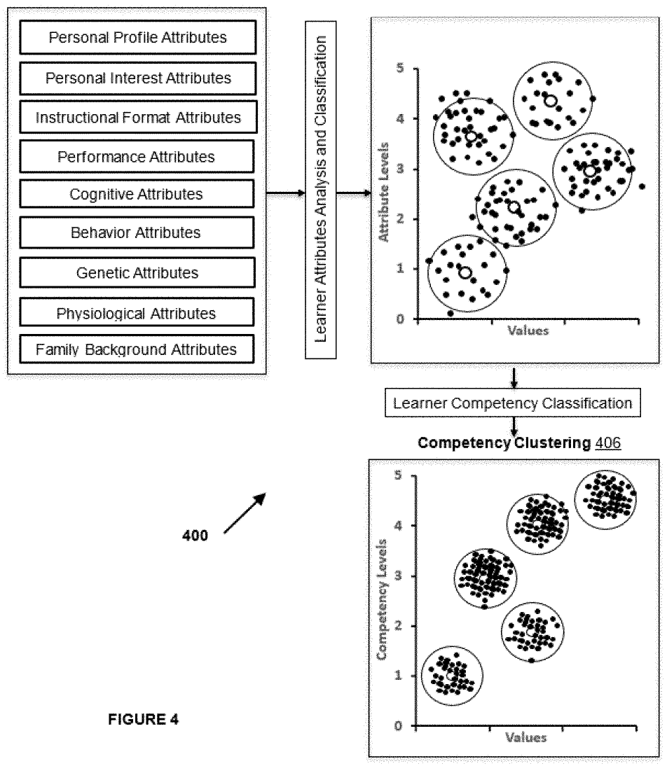

FIG. 4 is a diagram of a personalized and adaptive machine learning process 400 to analyze, classify and cluster various attributes and associated parameters, according to some embodiments. Process 400 includes of students' personal profile attributes (PPA) 402. Example students' personal profile attributes 402 can include, inter alia: age, gender, weight, height and so on. Personal interest attributes (PIA) include sports activities like soccer, baseball, table tennis, swimming, running, jogging and arts activities like drawing, painting. Personal instructional format attribute (IFA) includes teaching format like audio, video, step-by-step, slide, animations, class room and so on. Performance attributes (PMA) include their grade, competency in the subject matter, level of the student's current understanding of the domain content. Performance attributes can be based on previous learning scores, tests, quizzes, homework etc. Cognitive attributes (CGA) include working memory capacity, associative learning skill, inductive reasoning ability, information processing speed. Behavior attributes (BHA) include attentive, alert, calm, cheerful, bullying, cyberbullying, lack of engagement, disruptive in class, cheating, drug use, suspension, expulsion and so on. Genetic attributes (GTA) include physical disability, color blind, autism, intellectual disability, developmental delay, congenital anomalies, chromosomal abnormalities, copy number variations and so on. Genetic characteristics can refer to a genotype, which is a specific DNA sequence that code for special trait, or a phenotype. Physiological attributes (PHA) include of various physical parameters like stress levels can be calculated using the heart rate, blood pressure etc. students physical state can be determined using the rate of perspiration, pupil dilation, nervousness etc. Family background attribute (FMA) includes family education, family income, family marital status, family size, criminal activity, family structure and so on. Apart from the personal profile data, the machine learning method learns from the test data that has not been labeled and categorized, it identifies common items in the data and reacts based on the presence and absence of commonalities in each piece of data. The functional attribute levels are based on the data as follows:

F_{L} (PPA)={age, gender, weight, height, socio economic, . . . }

F_{L} (PIA)={physical sports, mind sports, competitive model sports, . . . }

F_{L} (IFA)={audio, video, step-by-step, slide, animations, class room, team based, instructor to learner, learner to learner . . . }

F_{L} (PMA)={grade, competency, level of understanding, . . . }

F_{L} (CGA)={memory capacity, associate learning skills, inductive reading ability, information processing speed, . . . }

F_{L} (BHA)={attentive, alert, calm, cheerful, goal-directed, fluent, spontaneous, engaging, open, stays on task, adaptable, bullying, cyberbullying, lack of engagement, disruptive in class, cheating, drug use, suspension, expulsion, . . . }

F_{L} (GTA)={physical disability, color blind, autism, intellectual disability, developmental delay, congenital anomalies, chromosomal abnormalities, copy number variations . . . }

F_{L} (PHA)={stress level, rate of perspiration, pupil dilation, nervousness, . . . }

F_{L} (FMA)={family education, family income, family marital status, family size, criminal activity, family structure, . . . }

As an example, the attribute level scale can be in the range of 1 to 5. The scale can be Poor=1, Fair=2, Good=3, Very Good=4, and Excellent=5.

First level of clustering is based on attribute clusters 404. It is created on set of each attribute of the above observations into subsets from all learners called clusters so that observations within the same attribute clusters are similar and the input attribute data can be mined correctly. Probabilistic assumption is made for missing attribute data based on the learner and the larger group data.

The second level of clustering is based on competency clusters 406. As an example, the competency cluster can be Novice=1, Beginner=2, Intermediate=3, Advanced=4 and Expert=5. These competency clusters are created from the first level attribute clusters.

The clustering analysis can be hierarchical, centroid, distribution and so on. In one of the scenarios centroid k-means algorithm can be used to assign the attribute to the nearest cluster center. In the first level of attribute clustering it is to the nearest attribute level mean and in case of the second level to the nearest competency mean.

First level attribute clustering at high level can be represented as Cluster C(A) a {F_{L}(A)}. Similarly, the second level of competency clustering can be represented as Cluster C(C) a All {F_{L}(A)}.

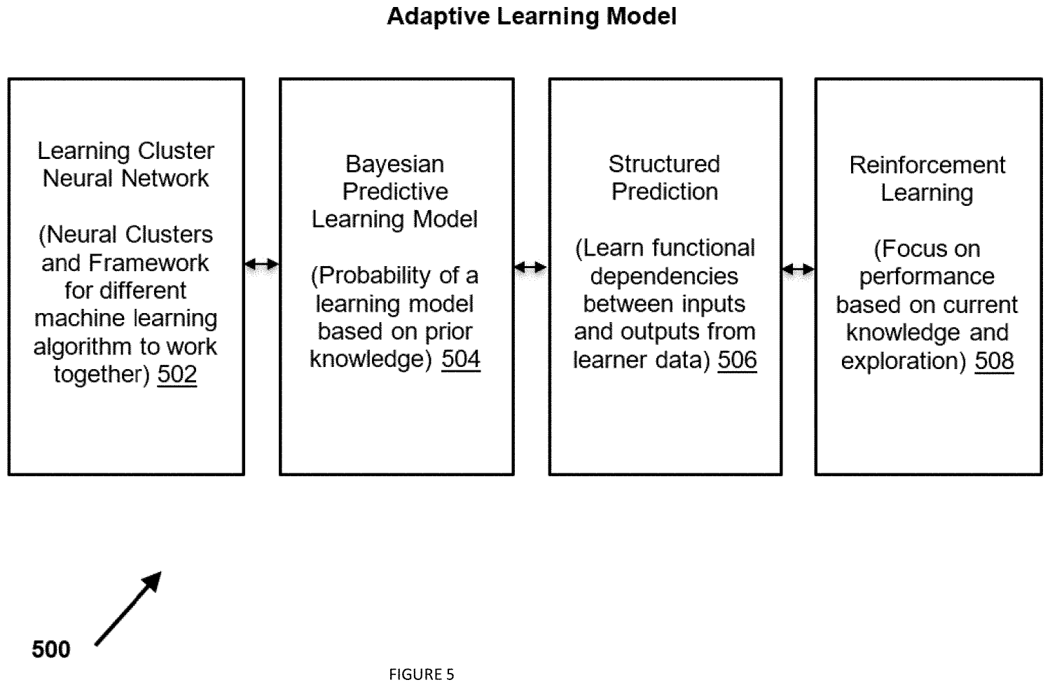

FIG. 5 illustrates an adaptive learning process 500, according to some embodiments. Process 500 creates a learning cluster neural network based on the student attribute data in step 502. It also acts as a framework for different machine learning algorithms.

In step 504, process 500 can implement a Bayesian predictive learning model. In step 506, process 500 can implement structured predictions. In step 508, process 500 can implement reinforcement learning.

The learning cluster neural network 502 model consists of input (attribute), the learning course modules (nodes or neurons) and the output are customized learning modules for each learner. The connection between input and neurons are called edge. The neurons and edges have weight that adjusts as learning proceeds.

It is noted that neural network learning cluster framework is based on the self-organizing maps and adaptive resonance theory.

The learner learning module is further refined using Bayesian predictive learning model 504 to accurately predict the learning module based on individual person profile and interest attribute data. This is done by calculating the probability that a given learning module will be true given probability of learner personal profile and interest data. This is further refined based on the sensitivity and specificity as well as positive predictive value (PPV) and negative predictive value (NPV).

After the applicable learning modules, have been selected the structured prediction model 506 uses the individual learners learning presentation format attributes to present the instructional methodologies consistent with the learners need. The individual lessons are combined to create a course (addition, subtraction etc.). Course can be further combined to create a curriculum for a given level (8^{th} grade, 9^{th} grade etc.).

For example, in the best-case scenario attributes value is around 5 (excellent) and competency level is around 5 at expert level. In this case the learner after few trial questions based on personal interest attribute takes the final quizzes to complete the lessons and course in the instructional format of its choice. In the worst-case scenario, the attributes value is around 1 (poor) and competency level is around 1 at novice level. In this case personalization of the content based on the attributes information becomes very critical for the learner to be able to complete the lessons and course. Most of the time the attributes value and competency level are somewhere in the range of 2 to 4. In this case after initial creation of the lessons and course it is extremely important to refine and customize the content based on personalize and adaptive machine learning methods. In case of class room, team and face to face based learning one can visually notice the attributes like genetic (intellectual disability), physiological (nervousness), instructional format (step by step method) and so on. In case of eLearning these input attributes data play an important role in figuring out the personalization of the content and ensure they can adapt to the learner environment by offering appropriate rewards. One important feature of this system is to detect the learning disabilities associated with genetic and physiological attributes. In the case of a learning disability being present in the student, the system recommends special education to support physical, emotional, and mental well-being.

The presentation environment could be based on content. In some cases, it is plain text, in other step by step process, video etc. Student assessment is done by comparing students' actual achievement with a desired standard of achievement as outlined in the lesson plan. The series of question can also be based on decision tree.

In the reinforcement learning 508 what actions an agent like intelligence group or program should take in an environment so as to maximize the cumulative reward is determined by sensing the various parameters and user interactions while taking a course. The learning style parameters like visual, auditory, reading, writing, and experimental are recorded. This information is used to present the lesson to the learner in the suitable instructional format so as to enhance the learning experience. The learner is also awarded the points, score, grades and so on based on the lesson completion.

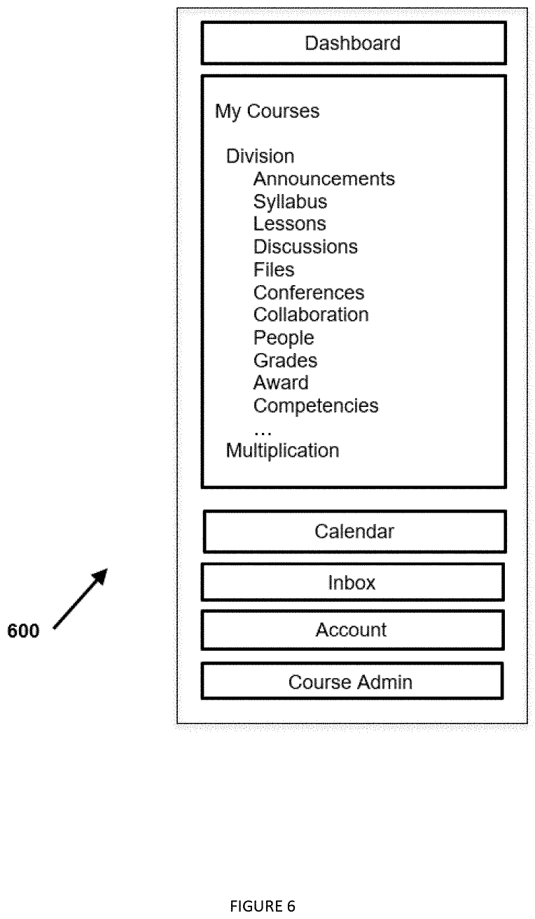

FIG. 6 illustrates an example software graphical user interface of the personalized and adaptive math learning application containing menu items for student and administrator, according to some embodiments. Example software graphical user interface 600, can be used to activate a user. The software includes of an application programmer interface (API) to allow user to create their own plug in applications. It includes of various menu items such as, inter glia: the dashboard with summary information about the courses taken, grades, individual lesson grades and learning speed. When the user clicks over a course, a complete set of details is provided. It also includes date started, date completed, teacher, and a detailed description of each of the lessons. My Courses provides has pull down menu with various courses. It includes of announcements, syllabus, lessons, discussions, files, conferences, collaborations, people, grades, award and competency information. Calendar displays current month courses and associated lessons. View can be customized in various formats such as weekly, monthly, yearly etc. Inbox has all the email interactions between student, admin, colleagues, collaborators etc. Account has information about user profile, settings, notifications and files. Course Administrator 204 access allows the teacher and instructor to create courses and lessons. It allows administrator enters to personalization attributes of the learner or import from other system. They also make updates based on the lesson as well as student feedback. The feedback could be in the discussion boards containing the brainstorming ideas on different topics. This results in an excellent course design and curriculum planning.

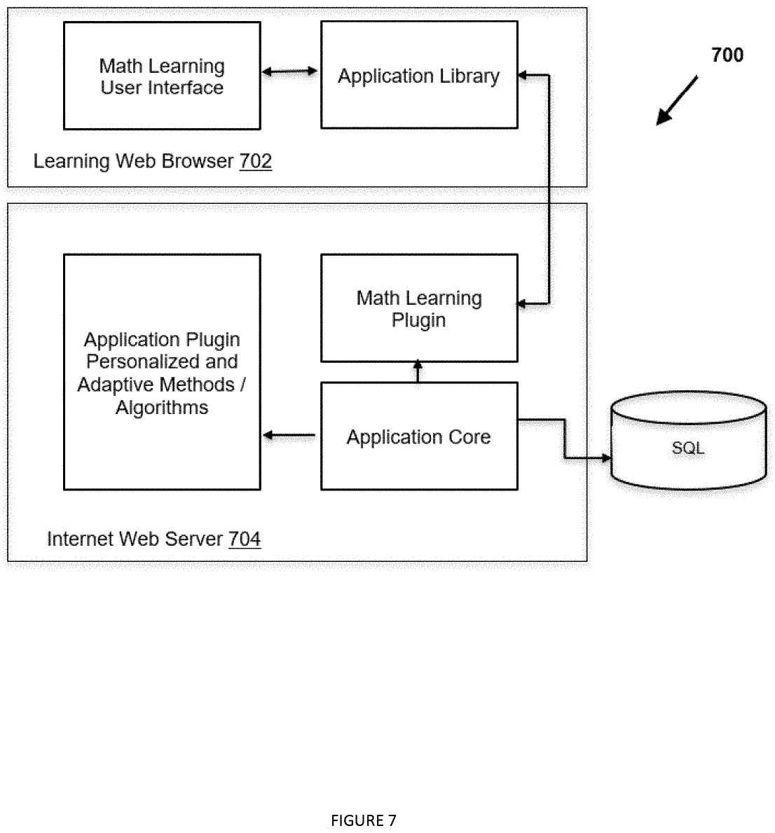

FIG. 7 illustrates an example personalized and adaptive math learning application software architecture 700 including a software user interface, methods, algorithms, and a database, according to some embodiments. Architecture 700 provides an adaptive lesson plan software architecture, which includes of a learner web browser 702 and an Internet web server 704 such as, for example, APACHE and TOMCAT. The math learning user interface and the software library are in the learner web browser. The math learning application plugin consisting of personalized and adaptive method/algorithms, the software core and all its parts are in the web server. This data in the database is accessed by Software Query Language (SQL).

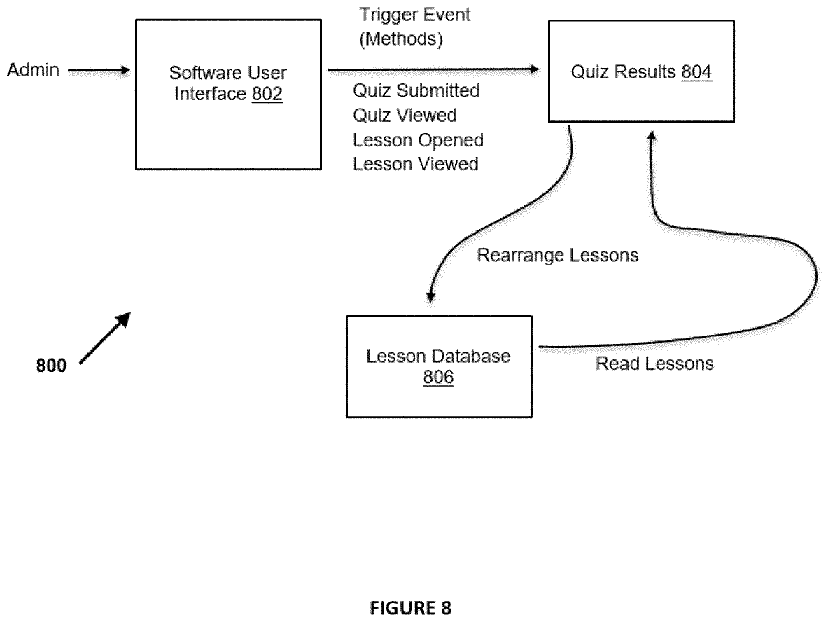

FIG. 8 is a diagram of an exemplary personalized and adaptive math learning software architecture 800 to implement various embodiments. Architecture 800 includes a software user interface 802. Architecture 800 includes a plugin that can make the application and its lessons 806 into the personalized and adaptive algorithm. It can include a trigger event, such as the quiz 804 being submitted and viewed or the lessons being submitted or viewed. Based on learner performance, the lessons 806 and quizzes 804 can be rearranged. The learner can be taken to another lesson or quiz based on their personalized algorithm. This can show up on the user interface.

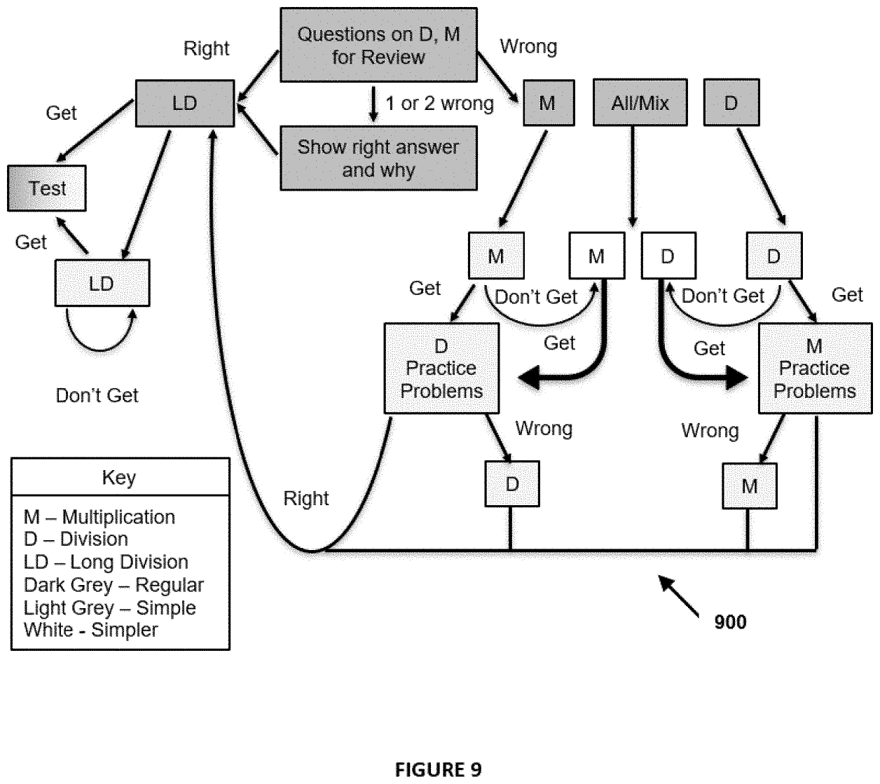

FIG. 9 illustrates an example block diagram of the personalized and adaptive math machine learning process 900, according to some embodiments. Process 900 can be configured to perform any one of the subject learning processes provided herein. For every lesson, the algorithm starts with a quiz comprising of multiple questions on simpler concepts that are required for the learner to know to complete the lesson efficiently. If the learner has most or all questions wrong, they are taken back to first learn these basic concepts before completing the lesson. In the case that the learner still is not able to understand these basic concepts, they are taken to easier and easier lessons until they finally do. If the learner has only a few or no questions wrong on the initial quiz, the interface can show the learner the correct way to solve the problems they got wrong and then can move on the complete the lesson. At the end of each lesson, there is a final quiz to make sure the student understands the concept before moving on to other lessons.

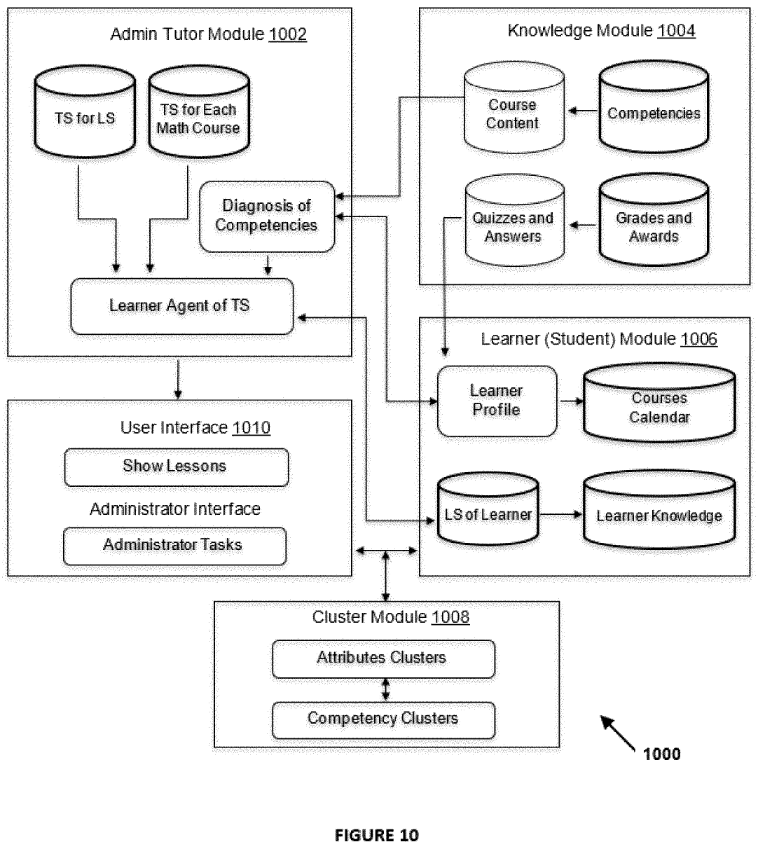

FIG. 10 illustrates an example block diagram of the personalized and adaptive lesson plan database design 1000 according to some embodiments. adaptive lesson plan database design 1000 is a block diagram of the database design that can be utilized to implement various embodiments. The database includes of a tutor module 1002, knowledge module 1004, student module 1006, and interface 1008. The tutor module 1002 comprises of teaching strategies, learning strategies, a selector agent of teaching strategies, and a diagnosis of competencies. The knowledge module 1004 comprises of course content, competencies on the subject content, quizzes and answers and grades and awards. This module keeps track of the student learning information. The student module 1006 comprises of learning strategies of the student, updates of knowledge, and the attributes information of the student. The information in the student module helps personalize the learning lessons. The clusters 1008 consists of Attributes and Competency clusters. The clusters data is created and stored based on learner profile attributes data, interactions, administrator input to present personalized and adaptive learning experience to achieve the expert level competency. The interface 1010 shows to the student their subjects, lessons, quizzes, and displays all the administrator data based on the login roles.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computer system useful for implementing personalized and adaptive mathematics learning, comprising;
a computer with an operating system and a memory;
wherein the memory comprises:
a pedagogical model, wherein the pedagogical model, wherein the pedagogical model provides and manages a virtual human-like interface between a student and a learning content in an online learning environment to guide a learning processes;
a domain model, wherein the domain model describes and models a set of real-world entities and relationships;
a student model, wherein student model describes attributes and provides a set of individualized course contents and study guidance, wherein the student model suggests a set of optimal learning objectives;
a machine learning module that implements a personalized and adaptive machine learning method, wherein the personalized and adaptive machine learning method presents a plurality of learning items to the student based on a set of attributes data and a student response;
a trial loop module that implements a trial loop comprising one or more learning trials, wherein the learning trials are presented to the student based on an answer to a question and the student response;
a question database comprising the plurality of learning items, wherein a learning item is presented on each learning trial; and
a trial record database that stores response data regarding the student's response to each learning item, wherein the response data includes data relating to accuracy;
a personalized and adaptive system that continues until the learner has achieved the highest level of competency.

2. The computer system of claim 1,
wherein a personalization process and adaptive learning process is implemented using the set of attributes data and the student response,
wherein personalization process comprises a set of learner attributes data for analysis, classification and clustering, and
wherein the adaptive process comprises a set of learning cluster neural networks, a Bayesian predictive learning model, a structured prediction and a reinforcement learning model.

3. The computer system of claim 2, wherein the personalized and adaptive machine learning method includes a personalized and adaptive algorithm.

4. The computer system of claim 3,
wherein the personalization process is based on student attributes;
wherein the student attributes comprise a personal profile, personal interests, personal instructional formats, performance values, cognitive skills, behavior values, genetic attributes, physiological characteristics, and family background characteristics;
wherein the system detects the learning capabilities and disabilities of a student;

5. The computer system of claim 4, wherein the learner attribute comprises multiple parameters that are analyzed, classified and clustered based on machine learning algorithms.

6. The computer system of claim 5, wherein the attribute cluster levels are created and classified as: Poor=1, Fair=2, Good=3, Very Good=4, and Excellent=5.

7. The computer system claim of 6, where in the competency cluster levels are created and classified as: Novice=1, Beginner=2, Intermediate=3, Advanced=4 and Expert=5.

8. The computer system of claim 7, wherein the adaptive learning of a new learner data is processed using the personalized and adaptive machine learning method.

9. The computer system of claim 1, wherein a trial question lesson plan database comprises a tutor module, a student module, a cluster module and a knowledge module.

10. The computer system of claim 9, wherein the trial record database comprises a student's accuracy response to each learning item.

11. The computer system of claim 10,
wherein the personalized and adaptive machine learning method comprises a set of questions in a quiz, and
wherein the set of questions change is based on a set of previously received responses.

12. The computer system of claim 11, wherein the lesson and the quiz change in complexity based on the student response.

13. The computer system of claim 12, wherein the quiz is provided at the beginning of each lesson that comprises a set of questions on concepts a set of knowledge to known by the student before the student starts the lesson.

14. The computer system of claim 13, wherein each time a student provides a correct answer in a quiz, a new question is presented.

15. The computer system of claim 14, wherein a student provides an incorrect answer in a quiz, an explanation of multiple ways to solve the question correctly is presented.

16. The computer system of claim 15, wherein an adaptive algorithm comprises as set of multiple different pathways that a student has taken based on an initial ability of the student to answer the quiz.

17. The computer system of claim 16, wherein a resort course algorithm shuffles a set of lessons and creates a set of adaptive pathways.

18. The computer system of claim 17, wherein at least three levels of complexity on concepts in the quiz are provided.

19. The computer system of claim 1,
wherein a customizable software user interface is provided, and
wherein the customizable software user interface comprises a dashboard, a course selection panel, a lesson trial item panel, a calendar, an inbox, an account, a course administrator and an administrative panel.
